(19) United States
(12) Patent Application Publication
(10) Pub. No.: US 2010/0105424 A1
(43) Pub. Date: Apr. 29, 2010

(54) Mobile Communications Device User Interface

(76) Inventors: Michael A. Smuga, Seattle, WA (US); Martijn E. Van Tilburg, Kirkland, WA (US); Alexandra K. Heron, Kirkland, WA (US); Michael J. Kruzeniski, Seattle, WA (US); Kenneth Q. Sabotta, Seattle, WA (US)

Correspondence Address: MICROSOFT CORPORATION, ONE MICROSOFT WAY, REDMOND, WA, 98052, US

(21) Appl. No.: 12/413,977

(22) Filed: Mar. 30, 2009

Related U.S. Application Data
(60) Provisional application No. 61/107,945, filed on Oct. 23, 2008.
(60) Provisional application No. 61/107,935, filed on Oct. 23, 2008.
(60) Provisional application No. 61/107,921, filed on Oct. 23, 2008.

(51) Int. Cl. H04M 1/00

(52) U.S. Cl. 455/550.1

(57) ABSTRACT

Mobile communications device user interface techniques are described. In an implementation, a mobile communications device receives an input via a QWERTY keyboard of the mobile communications device and translates one or more letters in the input into one or more corresponding numbers in accordance with a telephone keypad layout. A telephone call is placed using the one or more corresponding numbers.

### RELATED APPLICATIONS

This application claims priority under 35 U.S.C. Section 119(e) to U.S. Provisional Patent Application Nos. 61/107,945, 61/107,935, and 61/107,921, each of which was filed on Oct. 23, 2008, the entire disclosures of which are hereby incorporated by reference in their entirety.

### BACKGROUND

Mobile communications devices (e.g., wireless phones) have become an integral part of everyday life and in many instances have even replaced a user's home phone as a primary communication tool. However, mobile communications device generally have a relatively small form factor in order to increase mobility of the mobile communications device. However, use of a relatively small form factor may result in a variety of challenges in configuring the mobile communications device to include additional functionality.

For example, users were traditionally limited to telephone calls between mobile communications devices. Advances were then made to provide a variety of other communication techniques, e.g., text messaging and email. However, inclusion of these additional communication techniques on mobile communications devices may cause traditional techniques used to interact with the mobile communications device to become less desirable. For example, traditional input devices that were employed by traditional mobile communications devices may be inefficient when confronted with text-intensive functionality such as email, text messaging, and web browsing.

### SUMMARY

Mobile communications device user interface techniques are described. In an implementation, a mobile communications device receives an input via a QWERTY keyboard of the mobile communications device and translates one or more letters in the input into one or more corresponding numbers in accordance with a telephone keypad layout. A telephone call is placed using the one or more corresponding numbers.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an example implementation of a mobile communications device in accordance with one or more embodiments of devices, features, and systems for mobile communications.

FIG. 2 is a flow diagram depicting a procedure in an example implementation in which an input received via a QWERTY keyboard is translated in accordance with a telephone keypad layout.

FIG. 3 is an illustration of an example implementation showing a user interface module of FIG. 1 in greater detail as outputting a user interface of FIG. 2.

FIG. 4 is a flow diagram depicting a procedure in an example implementation in which a user interface is displayed that includes a search portion configured to accept inputs for locating contacts and telephone numbers.

FIG. 5 illustrates an example implementation of the mobile communications device of FIG. 1 as outputting the user interface of FIG. 4.

FIG. 6 illustrates various components of an example device that can be implemented in various embodiments as any type of a mobile communications device to implement embodiments of devices, features, and systems for mobile communications.

### DETAILED DESCRIPTION

### Overview

As the functionality of mobile communications devices has increased, use of conventional input devices to access this functionality may become increasingly frustrating. For example, composing an email using a conventional 12-key telephone keypad may involve double, triple and even quadruple “tapping” of a key to input a single letter. Similar frustrations may also be encountered when composing a text message, browsing the internet, interacting with an application, and so on.

One technique that was developed to address these challenges involved configuring the mobile communications device to include a QWERTY keyboard. Using a QWERTY keyboard, a user could often enter text with increased efficiency when compared with entry of text using a telephone keypad. However, because of the reduced size of the QWERTY keyboard some functionality may be lost. For example, a user may find it difficult to dial a “vanity” telephone number that is represented at least in part using letters (e.g., 1-800-FLOWERS) because the user may forget which number keys correspond to which letters.

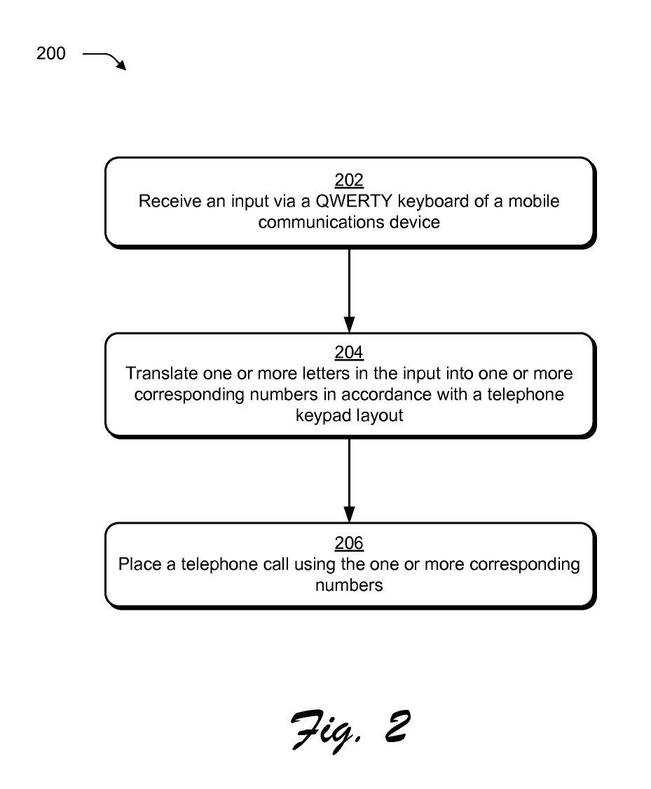

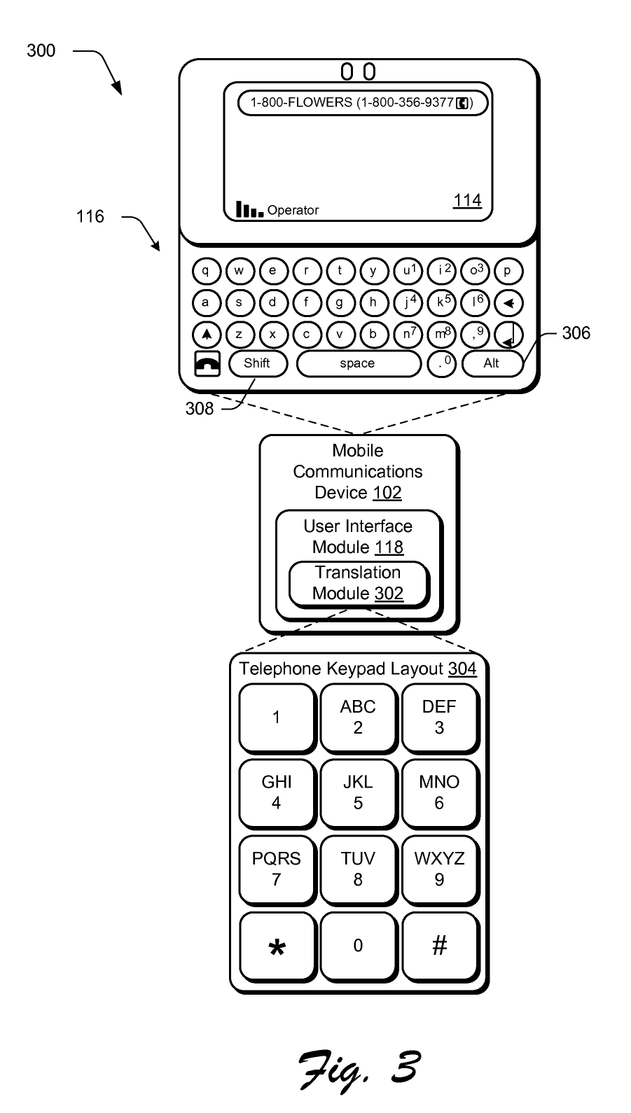

In an implementation, a mobile communications device (such as a mobile phone) is configured to translate letters entered via a QWERTY keyboard into numbers to place a telephone call. In this way, the telephone call may be quickly dialed without relying on a user to remember which number keys correspond to which letters in a telephone keypad layout. Further discussion of translation of QWERTY inputs may be found in relation to FIGS. 2-3.

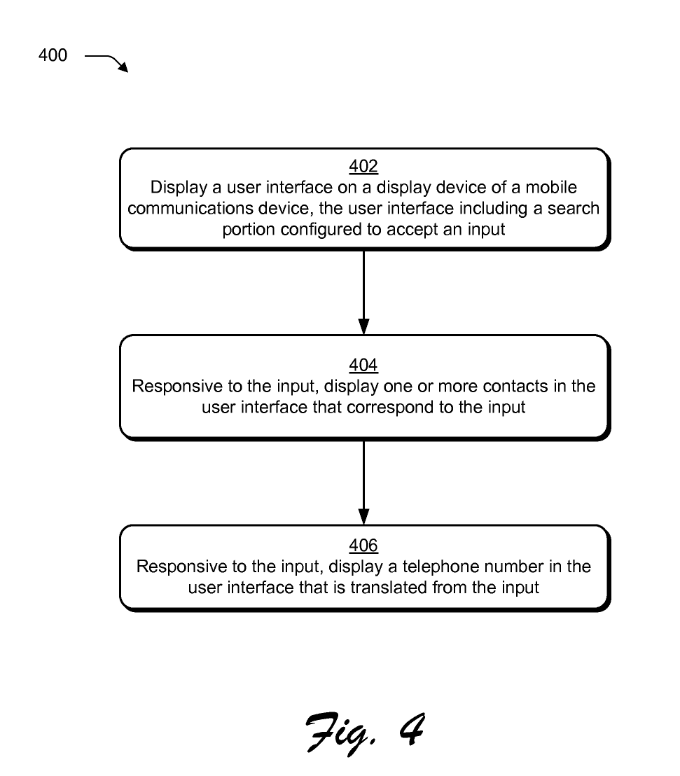

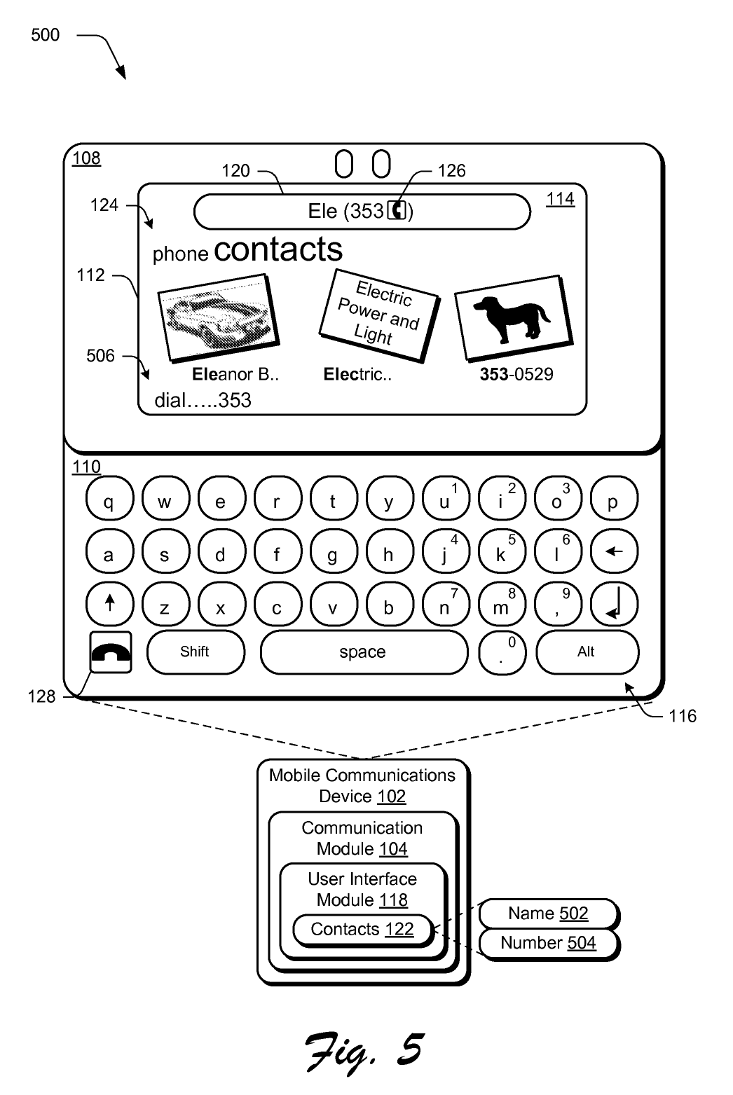

In another implementation, a user interface is configured to provide searching and telephone dialing from the single user interface. For example, when a user causes the mobile communications device to navigate to a “home screen,” there is an increased likelihood that the user intends to perform a search or dial a telephone number. Therefore, the user interface may be configured to provide a single search portion that may be used for both actions without navigating away from the user interface. For example, the user may provide a search query and receive search results in real time in the user interface that indicates contacts and/or phone numbers that correspond to the search query, further discussion of which may be found in relation of FIGS. 4-5.

In the following discussion, a variety of example implementations of a mobile communications device are shown. Additionally, a variety of different functionality that may be employed by the mobile communications device is described for each example, which may be implemented in that example as well as in other described examples. Accordingly, example implementations are illustrated of a few of a variety of contemplated implementations. Further, although a mobile communications device having one or more modules that are configured to provide telephonic functionality are described, a variety of other mobile communications devices are also contemplated, such as dedicated messaging devices, music players, portable game devices, and so on.

Example Environment

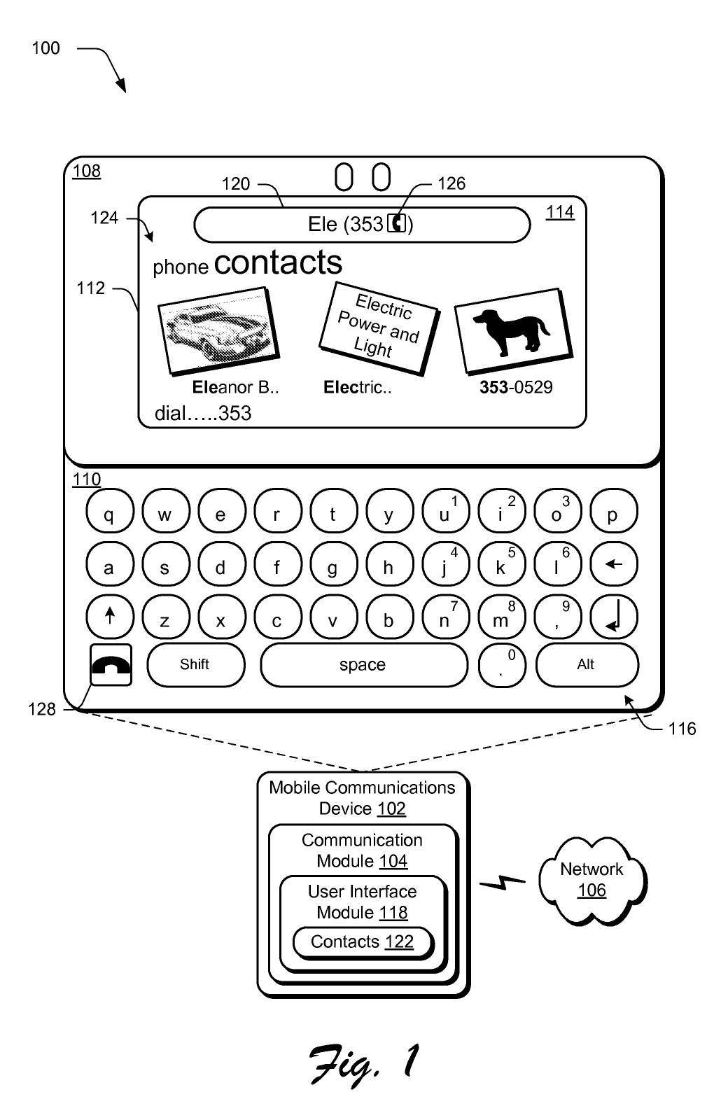

FIG. 1 is an illustration of an example implementation 100 of a mobile communications device 102 in accordance with one or more embodiments of devices, features, and systems for mobile communications. The mobile communications device 102 may be configured in a variety of ways, one such way being a mobile phone as illustrated in FIG. 1.

The mobile device 102 includes a communication module 104 that is representative of functionality to communicate with a network 106, such as to provide cellular phone, network connectivity and/or data retrieval functionality to various aspects of the environment 100. Accordingly, the network 106 may assume a wide variety of configurations. For example, the network 106 may include a cellular telephone network, the Internet, a wide area network (WAN), a local area network (LAN), a wireless network (e.g., a WIFI (IEEE 802.11) network), a public telephone network, an extranet, an intranet, and so on. Further, although a single network 106 is shown, the network 106 may be configured to include multiple networks. For instance, the mobile communications device 102, configured as a smart phone, may access a webpage within a corporate intranet via a cellular telephone network. A variety of other instances are also contemplated.

The mobile communications device 102 is illustrated as having first and second housings 108, 110, although a single housing or additional housings are also contemplated. The first housing 108 as illustrated includes a display device 112, which may be configured in a variety of ways. In embodiments, the display device 112 may comprise an LCD (Liquid Crystal Diode) display, a TFT (Thin Film Transistor) LCD display, an LEP (Light Emitting Polymer or PLED (Polymer Light Emitting Diode) display, and so forth, configured to display text and/or graphical information such as a graphical user interface 114. The display 112 may be backlit via a backlight such that it may be viewed in the dark or other low-light environments. In specific implementations, the display 112 may be provided with a touch screen 114 for entry of data and commands.

The second housing 110 as illustrated includes a QWERTY keyboard 116. The QWERTY keyboard 116 follows a QWERTY layout in which the keys for “Q,” “W,” “E,” “R,” “T,” and “Y” are the first six letter keys in a top row of letter keys. A QWERTY layout is typically employed to input letters in a Latin alphabet.

The mobile communications device 102 is also illustrated as including a user interface module 118. The user interface module 118 is representative of functionality of the mobile communications device 102 to generate the user interface 114 for output by the display device 112. A variety of different techniques may be employed to configure the user interface 114.

For example, the user interface module 118 may be configured to translate letters entered via the QWERTY keyboard 116 into numbers that correspond to a telephone keypad layout. In this way, a user may be able to dial “vanity” telephone numbers using the QWERTY keyboard 116 that are represented at least in part using letters (e.g., 1-PHILEAGLES, 1-800-PACKERS). Further discussion of translation techniques that may be implemented using the user interface module 118 may be found in relation to FIGS. 3-4.

In another example, the user interface 114 may be configured to include an search portion 120 configured to receive one or more inputs, such as through typing on the QWERTY keyboard 116 after selection of the search portion 120. In an implementation, the inputs may be displayed in the search portion 120 without manually selecting the search portion 120. For instance, the search portion 120 may be displayed as part of a home screen of the mobile communications device 102. When the home screen is being displayed, pressing one or more keys of the QWERTY keyboard 116 may automatically cause respective letters, numbers, or symbols to be input automatically into the search portion 120.

When the user is on the home screen, for instance, the user has an increased likelihood of desiring performance of either of two actions: a search (e.g., for one or more contacts 122) or dialing a telephone number. Therefore, in this example the user interface module 118 may configure the user interface 114 to allow the user to perform a search query or dial a number via the search portion 120. As the user provides inputs (e.g., via the QWERTY keyboard 116), the query is displayed in the search portion 120. Additionally, search results 124 may be updated automatically as the user types, which are illustrated as a list of contacts that include corresponding letters and/or numbers in the user interface 114 of FIG. 1.

Corresponding numbers may also be output in the user interface 114 that correspond to a telephone keypad layout as described in the previous example. In an implementation, selecting the phone icon 126 and/or the phone hardware key 128 causes the mobile communications device 102 to dial the telephone number. It should be readily apparent that these techniques may be employed in a variety of other instances other than a home screen, further discussion of which may be found in relation to FIGS. 4-5.

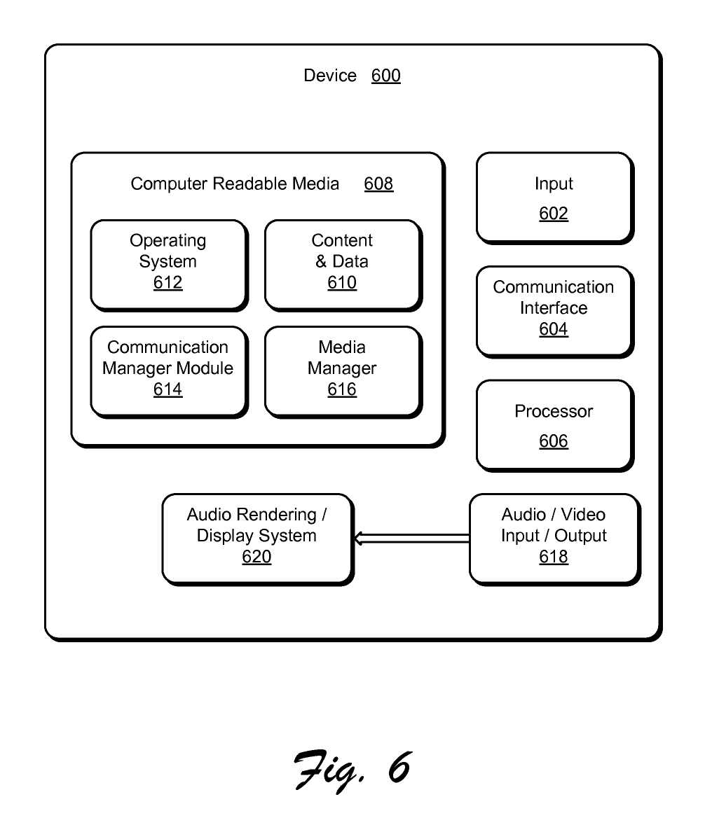

Generally, any of the functions described herein can be implemented using software, firmware (e.g., fixed logic circuitry), manual processing, or a combination of these implementations. The terms “module,” “functionality,” and “logic” as used herein generally represent software, firmware, or a combination of software and firmware. In the case of a software implementation, the module, functionality, or logic represents program code that performs specified tasks when executed on a processor (e.g., CPU or CPUs). The program code can be stored in one or more computer readable memory devices, further description of which may be found in relation to FIG. 6. The features of the user interface techniques described below are platform-independent, meaning that the techniques may be implemented on a variety of commercial computing platforms having a variety of processors.

Example Procedures

The following discussion describes user interface techniques that may be implemented utilizing the previously described systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. In portions of the following discussion, reference will be made to the environment 100 of FIG. 1.

FIG. 2 depicts a procedure 200 in an example implementation in which an input received via a QWERTY keyboard is translated in accordance with a telephone keypad layout. During the discussion of FIG. 2, reference will also be made to FIG. 3 which illustrates an example implementation of the mobile communications device 102 of FIG. 1 as outputting a user interface in accordance with FIG. 2.

An input is received via a QWERTY keyboard of a mobile communications device (block 202). For example, a user may enter “1800” and press letter keys “F,” “L,” “0,” “W,” “E,” “R,” and “S”.

One or more letters in the input are translated into one or more corresponding number in accordance with a telephone keypad layout (block 204). Referring now to FIG. 3, an example implementation 300 is illustrated showing the user interface module 118 of FIG. 1 in greater detail. The user interface module 118 is illustrated as including a translation module 302. The translation module 302 is representative of functionality to translate inputs received via the QWERTY keyboard 116 according to a telephone keypad layout 304.

As illustrated by the telephone keypad layout 304, letters of the alphabet were mapped to respective numbers to support “vanity” numbers. For example, the letters A, B, and C map to a number 2; letters D, E, and F map to a number 3; letters G, H, and I map to a number 4; letters J, K, and L map to a number 5; letters M, N, and O map to a number 6; letters P, Q, R, and S map to a number 7; letters T, U, and V map to a number 8; and letters W, X, Y, and Z map to a number 9 in the telephone keypad layout. Therefore, to dial a vanity number using the telephone keypad layout 304 a user generally pressed a number that corresponded to a letter displayed on the key.

However, in a QWERTY keyboard 116 used by a mobile communications device 102, the keyboard may not have sufficient space to display each of these letters on a single key. Therefore, the translation module 302 may be employed to translate a letter that corresponds to a key in the QWERTY keyboard 116 according to the telephone keypad layout 304. For instance, as illustrated in FIG. 3 the user may enter 1-800-FLOWERS via the QWERTY keyboard 116 and have it translated to the telephone number “1-800-356-9377.” A telephone call may then be placed using the one or more corresponding numbers (block 206). A variety of other implementations for translation of inputs provided by a QWERTY keyboard are also contemplated.

For example, in some instances a subset of the keys of the QWERTY keyboard 116 employed by the mobile communications device 102 may be configured to provide alternative inputs. In the illustrated instance in FIG. 3, a key is configured to provide an input of a “u” or an input of a “1” when an “alt” key 306 is also pressed. Therefore, selection of first and second keys (e.g., the “u” key and the “alt” key 306) may be used to input a “1,” such as to dial a telephone number.

However, these alternate inputs may complicate entry of a telephone number that is represented at least in part using letters. For instance, when the user presses “u” it may be unclear as to whether the “u” should be counted as a 1 (since the “u” and the “1” share a key in the illustrated example) or as “8” according to the telephone keypad layout 304.

Therefore, to distinguish these instances a second key be may used to specify which input is intended. For example, to dial 1-800-FLOWERS the user may hold a SHIFT key 308 when inputting the letters FLOWERS. In this way, the translation module 302 may determine that the user intends to dial “FLOWERS” that should map to 3563911 and not F63WERS in the illustrated example. A variety of other examples are also contemplated, e.g., 1-800-CARS-4-US.

FIG. 4 depicts a procedure 400 in an example implementation in which a user interface is displayed that includes a search portion configured to accept inputs for locating contacts and telephone numbers. During the discussion of FIG. 4, reference will also be made to FIG. 5 that illustrates an example implementation 500 of the mobile communications device 102 of FIG. 1.

A user interface is displayed on a display device of a mobile communications device, the user interface including a search portion configured to accept an input (block 402). For example, the search portion 120 may be displayed in a user interface 114 and configured to accept one or more inputs via the QWERTY keyboard 116, although other keyboards are also contemplated.

Responsive to the input, one or more contacts are displayed in the user interface that correspond to the input (block 404). The contacts 122 may correspond in a variety of ways. For example, the contacts 122 may correspond by name 502 by including one or more letters of the input, examples of which are illustrated in the user interface 114 as “Eleanor” and “Electric” for an input “ele” in the search portion 120.

The contacts 122 may also correspond by number 504, such as the telephone number “353-0529” in which the numbers “353” correspond to the input “ele” as translated according to a telephone keypad layout 304 as described in relation to the translation techniques of FIGS. 2-3. A variety of other examples are also contemplated, such as the name 502 and/or number 504 being included in an address of the contacts 122. In this example, the search results (e.g., the contacts displayed in the user interface 114) may be updated in real time as the input is received via the search portion 120.

Responsive to the input, a telephone number is displayed in the user interface that is translated from the input (block 406). As illustrated in FIG. 5, for instance, the translated input is displayed in the search portion 120 and another portion 506. In this example, the telephone number may be updated in real time as the input is received. A variety of other examples are also contemplated.

Example Mobile Communications Device

FIG. 6 illustrates various components of an example device 600 that can be implemented in various embodiments as any type of a mobile communications device to implement embodiments of devices, features, and systems for mobile communications. For example, device 600 can be implemented as any of the mobile communications devices 102 described with reference to respective FIGS. 1-5. Device 600 can also be implemented to access a network-based service, such as a content service.

Device 600 includes input(s) 602 that may include Internet Protocol (IP) inputs. Device 600 further includes communication interface(s) 604 that can be implemented as any one or more of a wireless interface, any type of network interface, and as any other type of communication interface. A network interface provides a connection between device 600 and a communication network by which other electronic and computing devices can communicate data with device 600. A wireless interface enables device 600 to operate as a mobile communications device for wireless communications, such as to include telephone functionality to operate as a mobile phone.

Device 600 also includes one or more processors 606 (e.g., any of microprocessors, controllers, and the like) which process various computer-executable instructions to control the operation of device 600 and to communicate with other electronic devices. Device 600 can be implemented with computer-readable media 608, such as one or more memory components, examples of which include random access memory (RAM) and non-volatile memory (e.g., any one or more of a read-only memory (ROM), flash memory, EPROM, EEPROM, etc.).

Computer-readable media 608 provides data storage to store content and data 610, as well as device applications and any other types of information and/or data related to operational aspects of device 600. For example, an operating system 612 can be maintained as a computer application with the computer-readable media 608 and executed on processor(s) 606. Device applications can also include a communication manager module 614 (which may be used to provide telephonic functionality) and a media manager 616 which may be configured to implement one or more of the previously described techniques.

Device 600 also includes an audio and/or video output 618 that provides audio and/or video data to an audio rendering and/or display system 620. The audio rendering and/or display system 620 can be implemented as integrated component(s) of the example device 600, and can include any components that process, display, and/or otherwise render audio, video, and image data. Device 600 can also be implemented to provide a user tactile feedback, such as vibrate and haptics.

Generally, the blocks may be representative of modules that are configured to provide represented functionality. Further, any of the functions described herein can be implemented using software, firmware (e.g., fixed logic circuitry), manual processing, or a combination of these implementations. The terms “module,” “functionality,” and “logic” as used herein generally represent software, firmware, or a combination of software and firmware. In the case of a software implementation, the module, functionality, or logic represents program code that performs specified tasks when executed on a processor (e.g., CPU or CPUs). The program code can be stored in one or more computer readable memory devices. The features of the techniques described above are platform-independent, meaning that the techniques may be implemented on a variety of commercial computing platforms having a variety of processors.

### CONCLUSION

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method implemented by a mobile communications device, the method comprising:
receiving an input via a QWERTY keyboard of the mobile communications device;
translating one or more letters in the input into one or more corresponding numbers in accordance with a telephone keypad layout; and
placing a telephone call using the one or more corresponding numbers.

2. A method as described in claim 1, wherein the translating is performed as follows:
letters A, B, and C are translated to a number 2 in the telephone keypad layout;
letters D, E, and F are translated to a number 3 in the telephone keypad layout;
letters G, H, and I are translated to a number 4 in the telephone keypad layout;
letters J, K, and L are translated to a number 5 in the telephone keypad layout;
letters M, N, and O are translated to a number 6 in the telephone keypad layout;
letters P, Q, R, and S are translated to a number 7 in the telephone keypad layout;
letters T, U, and V are translated to a number 8 in the telephone keypad layout; and
letters W, X, Y, and Z are translated to a number 9 in the telephone keypad layout.

3. A method as described in claim 1, wherein at least one said input is formed by selecting first and second keys of the QWERTY keyboard simultaneously to specify a particular one of at least two alternative inputs for the second key.

4. A method as described in claim 3, wherein the particular one of the at least two alternative inputs is a letter and another one of the at least two alternative inputs is a number.

5. A method as described in claim 3, wherein the first or second key is a shift key.

6. A method as described in claim 1, wherein the QWERTY keyboard is implemented in hardware.

7. A method as described in claim 1, wherein:
a subset of keys of the QWERTY keyboard includes a representation of a letter and a number; and
the numbers follow a telephone keypad layout.

8. One or more tangible computer-readable media comprising instructions that are executable by a mobile communications device to:
display a user interface on a display device of the mobile communications device, the user interface including a search portion configured to accept an input; and
responsive to the input:
display one or more contacts in the user interface that correspond to the input; and
display a telephone number in the user interface that corresponds to the input.

9. One or more tangible computer-readable media as described in claim 8, wherein the mobile communications device includes a QWERTY keyboard and the instructions are further configured to translate the input received via the QWERTY keyboard into numbers to form the telephone number according to a telephone keypad layout.

10. One or more tangible computer-readable media as described in claim 9, wherein in the telephone keypad layout:
letters A, B, and C correspond to a number 2;
letters D, E, and F correspond to a number 3;
letters G, H, and I correspond to a number 4;
letters J, K, and L correspond to a number 5;
letters M, N, and O correspond to a number 6;
letters P, Q, R, and S correspond to a number 7;
letters T, U, and V correspond to a number 8; and
letters W, X, Y, and Z correspond to a number 9.

11. One or more tangible computer-readable media as described in claim 8, wherein:
the mobile communications device includes a QWERTY keyboard and the instructions are further configured to translate the input received via the QWERTY keyboard into one or more numbers according to a telephone keypad layout; and
the one or more contacts correspond to the input by including the one or more numbers.

12. One or more tangible computer-readable media as described in claim 8, wherein the one or more contacts correspond to the input by including one or more letters of the input in a name of the contact.

13. One or more tangible computer-readable media as described in claim 8, wherein the one or more contacts correspond to the input by including one or more letters of the input in a name of the contact.

14. One or more tangible computer-readable media as described in claim 8, wherein the instructions cause the display of the one or more contacts and the display of the telephone number to be updated in real time as successive said inputs are received.

15. A mobile communications device comprising:
a display device;
a QWERTY keyboard; and
one or more modules that are configured to place a telephone call and translate one or more letters in an input received via the QWERTY keyboard into corresponding numbers to be used to place the telephone call in which:
letters A, B, and C are translated to a number 2;
letters D, E, and F are translated to a number 3;
letters G, H, and I are translated to a number 4;
letters J, K, and L are translated to a number 5;
letters M, N, and O are translated to a number 6;
letters P, Q, R, and S are translated to a number 7;
letters T, U, and V are translated to a number 8; and
letters W, X, Y, and Z are translated to a number 9.

16. A mobile communications device as described in claim 15, wherein the one or more modules are further configured to:
display a user interface on the display device having a search portion configured to accept an input;
display one or more contacts in the user interface that correspond to the input; and
display the telephone number in the user interface that corresponds to the input.

17. A mobile communications device as described in claim 16, wherein the one or more contacts correspond to the input by including one or more letters of the input in a name of the contact.

18. A mobile communications device as described in claim 16, the one or more contacts correspond to the input by including one or more letters of the input in a name of the contact.

19. A mobile communications device as described in claim 16, wherein the one or more modules cause the display of the one or more contacts and the display of the telephone number to be updated in real time as successive said inputs are received.

20. A mobile communications device as described in claim 15, wherein:
at least one said input is formed by selecting first and second keys of the QWERTY keyboard simultaneously to specify a particular one of at least two alternative inputs for the second key; and
the particular one of the at least two alternative inputs is a letter and another one of the at least two alternative inputs is a number.
